(19) United States
(12) Patent Application Publication
(10) Pub. No.: US 2002/0007488 A1
(43) Pub. Date: Jan. 17, 2002

(54) Transparent object management for removable media recorders

(76) Inventors: Dan Kikinis, Saratoga, CA (US); Yakov Kamen, Cupertino, CA (US)

Correspondence Address: John P. Ward, BLAKELY, SOKOLOFF, TAYLOR & ZAFMAN LLP, 12400 Wilshire Boulevard, Seventh Floor, Los Angeles, CA, 90025-1026, US

(21) Appl. No.: 09/858,762

(22) Filed: May 15, 2001

Related U.S. Application Data
(63) Continuation-in-part of application No. 09/661,164, filed on Sep. 13, 2000.
(60) Provisional application No. 60/212,697, filed on Jun. 19, 2000.

(51) Int. Cl. H04N 7/173; H04N 5/445

(52) U.S. Cl. 725/40; 725/142; 725/110

(57) ABSTRACT

A removable storage medium with the ability to receive recorded programs as well as objects related to those programs is provided. When a user chooses to record a movie or other program (e.g., from a television system), or to transfer a recording to the removable storage medium, associated objects such as overlays, annotations, and links are copied along with it, so that they will be available over time. The removable storage medium may be used in connection with an EPG system that displays programming information in a variety of ways including using 3-D images, alphanumeric text, and video data and that can allow viewers and/or programmers to select between varying programming worlds.

This application claims the benefit of U.S. Provisional Patent application No. 60/212,697 filed on Jun. 19, 2000, entitled “Transparent Object Management for Removable Media Recorders” and the application is a continuation in part of U.S. Nonprovisional Patent application no. 09/661,164 filed on Sep. 13, 2000, entitled “Insertion of Recorded Media into a Broadcast.”

### FIELD OF THE INVENTION

The present invention relates generally to electronic programming guides and, more particularly, to a programming system for an electronic programming guide with a removable storage medium to receive recorded movies as well as objects related to those movies.

### BACKGROUND OF THE INVENTION

Electronic programming guides (EPGs) are often programmed for set-top boxes (STBs), which typically have a low-speed CPU and extremely limited memory. Such EPGs are simple and limited in functionality. For example, most of these EPGs operate in the same basic fashion: scheduled program information is transmitted to a STB on a viewer's premises by an appropriate form of transmission (e.g., broadcast, direct satellite, cable, etc.). The set-top box CPU retains the transmission in memory so that the scheduled programming information may be subsequently viewed on a viewer's television set in response to user-generated signals. The information generally appears in a grid structure on the television screen with multiple columns corresponding to a designated time slot (e.g., 30 minutes) and multiple rows corresponding to a different television channel.

Any minimal design upgrade of the user interface or other EPG functions requires significant redesign of the EPG and reprogramming of the STB. As a result, broadcasters and content developers cannot easily upgrade the software in existing EPGs, and are often even required to replace the hardware, or at least upgrade the memory, CPU, etc. Moreover, because of the limited resolution quality of conventional television screens, the viewer can only see about 1.5 hours of programming at a time for only a few channels. In addition, current EPGs allow for only one font size. Unfortunately, viewers do not all have the same depth of vision. Therefore, some viewers may be unable to read the programming information on the television screen. Confounding this problem is the fact that existing EPGs do not have very advanced lighting capabilities, which detracts from the functionality of the EPG.

Furthermore, it is desirable for EPG updates, in some instances, to be localized and to thus not be broadcast in all locations over the broadcast stream, as is usual for scheduled objects. At the same time tremendous growth in CPU performance and significant CPU and memory price decline have created opportunities to design more complex and intelligent EPGs to satisfy this need. Yet prior art EPGs have been unable to bring objects with intelligent behavior into a local EPG system.

In addition, in some instances a user may be interested in a show that has already been broadcast. For example, a user may remember an episode of a particular television series and want to see it again. Typically, EPGs don't make information available regarding past programming. In general, events that are either immediately over or are more than a day or so old are dumped to make room in the limited resources of the set-top box (such as the memory, hard disk, etc.) for objects that are downloaded for new and incoming requests.

As technology has advanced, set-top boxes have started to include recording devices, typically contained in a hard disk. The devices of the prior art have often included capabilities to do either real-time encoding of analog video into MPEG2 or transfer of MPEG streams into a stored MPEG2 stream on the hard disk. Although such recordings can be stored in one or multiple files, the storage capacity is limited to the capacity of the hard disk. Currently, typical storage capacities offered are 20 and 30 hours, which corresponds to approximately 20 GB and 30 GB hard disks. Although hard disk capacities can be expected to increase, they are ultimately limited, and users will want to store files until they eventually exceed the available capacity of their hard disk.

### SUMMARY OF THE INVENTION

The present invention provides an improved EPG that can display programming information in a variety of ways (e.g., 3-D images, alphanumeric text, and video data) and that also allows viewers and/or television programmers to select between varying programming worlds according to viewer and/or programmer preferences.

An EPG in accordance with an embodiment of the present invention provides for a memory or database which contains objects a through n. One class of objects is a pseudo-descriptive language that describes, for example, program events or schedule times. Such an object has a title and/or a channel ID that can be converted into the actual channel number or program association (e.g., Channel 7 equals ABC, etc.).

In a further aspect of the present invention, an additional class of objects contains a variety of world descriptions. This class of objects provides a 3-D enabled EPG, including a 3-D virtual world whose end result is the view that the user gets.

Such multiple user interfaces, environments, and even logics may be loaded into the same device at the same time, and by choosing a particular EPG world, various layouts may be achieved. One layout may mimic the look of a classic 2-D EPG approach. Another layout may mimic, for example, a futuristic science fiction type of environment in space, with rotating carousels showing movie previews, etc. A third layout may offer, for example, an environment mimicking video games such as DOOM™, etc. In addition, there may be a dynamic relationship between the selection of content by a user and the selection of a specific world (e.g., the selection of the sports channel by the user changes the world to a ballpark, the selection of the Disney channel changes the world to a Disney world, etc.).

In these various environments, channels may be organized by different classes so that the EPG world may contain, in addition to its layout and descriptions, one through n elements with objects. In turn, each of these objects may be linked or assigned to one of the items to display, such as schedule items, etc. In addition, there may be non-EPG objects, such as interaction objects. These may be used for e-commerce activities, etc., and may be conflated with the presentation of the world along with the programming schedule items.

In a further aspect of the present invention objects with intelligent behavior may be brought into a local EPG system. An interactive network link uploads in real time new objects with localized content and transmits those new objects via a software driver acting as a connector into the memory or database.

In still a further aspect of the present invention an added offline archive stores objects for an additional, predetermined time such as a week, a month, a year, or even longer after the presentation of a scheduled event. A user may look up details regarding a past show, such as the date and time it played, the exact title of the show, etc. Additional services related to past programming may also be provided, including the ability to download past episodes of specific shows in a manner similar to an interactive video-on-demand environment. In addition, a removable medium allows storage of recorded digital video, such that associated information and objects can be stored along with the main video file. In this manner, subsequent viewing of the stored video is the same full experience as it is when watching the original broadcast on live television.

### BRIEF DESCRIPTION OF THE DRAWINGS

The present invention is illustrated by way of example, and not limitation, in the figures of the accompanying drawings in which like reference numerals refer to similar elements and which:

FIG. 1 shows a block diagram of a conventional EPG system according to the prior art.

FIG. 2a shows an overview of the software architecture of a programming system for an EPG according to an embodiment of the present invention.

FIG. 2b shows the overview of the software architecture of the programming system for the EPG of FIG. 2a including an interactive network communication block.

FIG. 2c shows the overview of the software architecture and interactive network communication block of FIG. 2b including an additional long-term storage database.

FIG. 2d shows the embodiment of the invention illustrated by FIG. 2c with the addition of a removable storage medium.

FIG. 3a shows a pseudo-descriptive language containing one class of objects for an EPG according to an embodiment of the present invention.

FIG. 3b shows a description of a 3-D world in another class of objects for an EPG according to an embodiment of the present invention.

FIG. 3c shows a description of a non-EPG object according to an embodiment of the present invention.

FIG. 4 is one example of a computer system according to an embodiment of the present invention.

### DETAILED DESCRIPTION

Described herein is a transparent object management system and method for removable media recorders. Throughout the following description specific details are set forth in order to provide a more thorough understanding of the invention. However, the invention may be practiced without these particulars. In other instances, well known elements have not been shown or described in detail to avoid unnecessarily obscuring the present invention. Accordingly, the specification and drawings are to be regarded in an illustrative, rather than a restrictive, sense.

One limitation of prior art EPGs is that they are unsophisticated. That is, programming information is typically displayed in a grid structure on a television screen. This information is often not very detailed and may be difficult for some viewers to read. Another limitation of prior art EPGs is that objects with intelligent behavior have been unable to be brought into a local EPG system. Moreover, prior art EPGs do not retain programming information after the presentation of a scheduled event. If viewers are trying to recollect details regarding a particular television show, for instance, they are usually limited to back issues of TV Guide or to television schedules that appeared in local newspapers, which are often hard to find.

It would be helpful if an improved EPG system existed to allow users to display past and present programming information in a variety of ways (e.g., including 3-D images) and to allow users to vary programming worlds according to certain preferences. Moreover, it would also be helpful if objects with localized interactive content could be brought into the EPG system. A removable medium coupled to the set-top box to allow storage of recorded digital video such that associated information and objects could be stored along with the main video file would also prove beneficial.

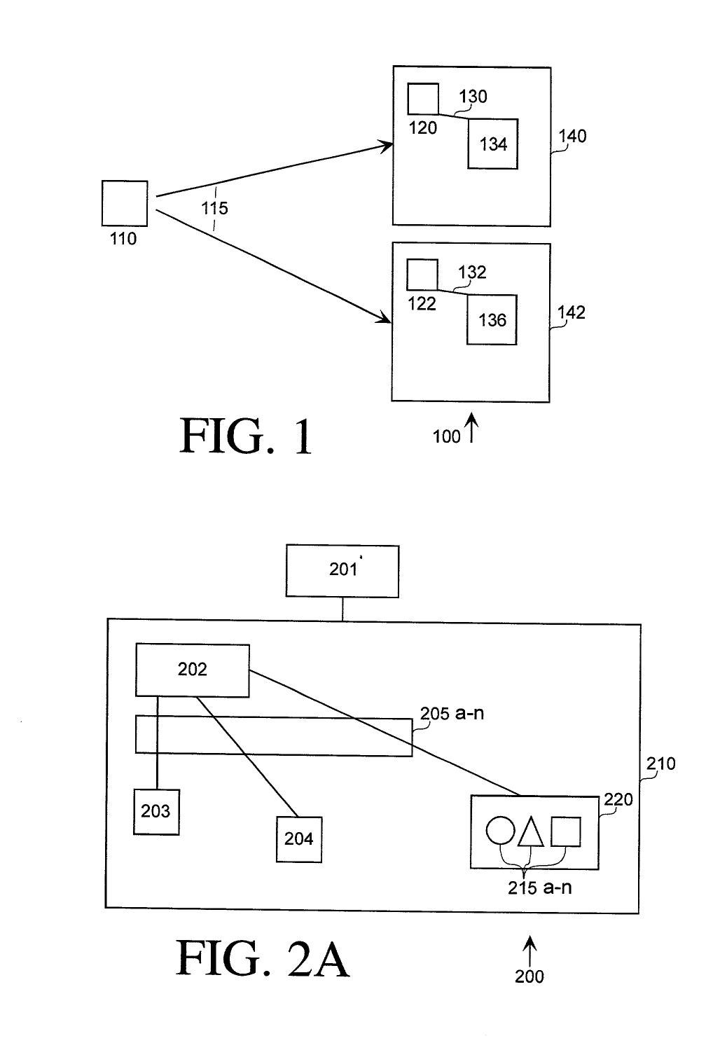

Referring now to FIG. 1 there is shown a block diagram of a conventional EPG system 100 according to the prior art. A service provider 110 such as a broadcaster or a cable television provider, broadcasts a transmission 115 to a plurality of subscribers, each having a set-top box 120 and 122, etc. Signal may be distributed and received through a variety of means, including optical, microwave, electrical or other forms of transmission. Signal includes EPG data 130 and 132, etc., which is displayed on television screens 134 and 136, etc., as part of television systems 140 and 142, etc. EPG data 130 and 132, etc., is displayed in a matrix of rectangular boxes containing text (not shown in this view) in a manner well known in the art.

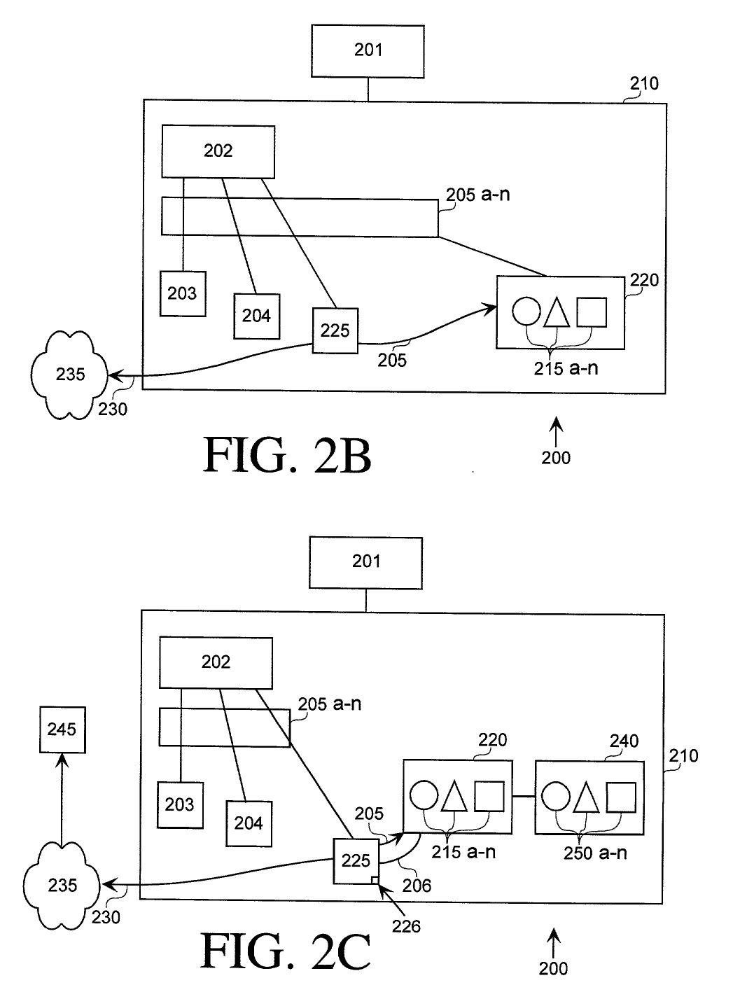

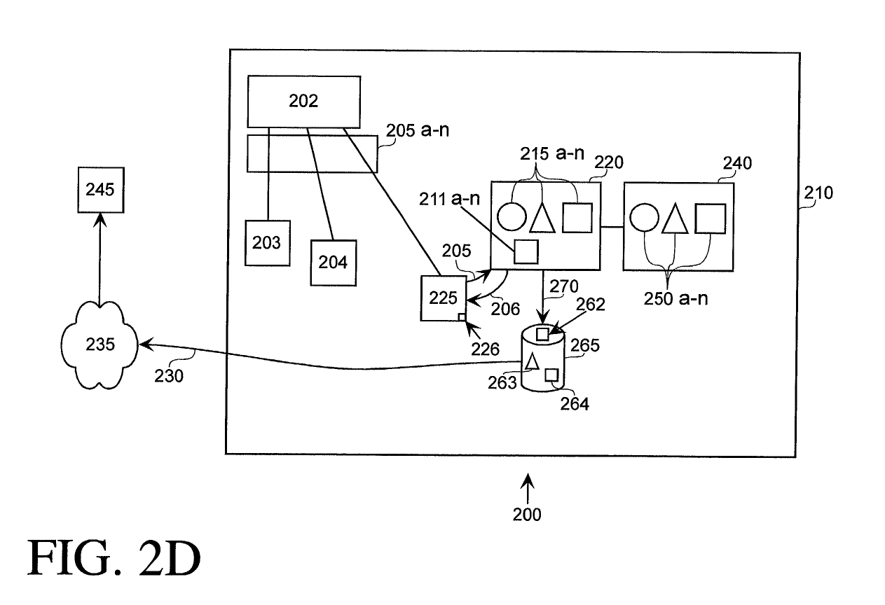

Referring now to FIG. 2a there is shown an overview of the software architecture of a programming system for an EPG 200 according to an embodiment of the present invention. The present invention may be implemented in any television system (not shown in this view) including analog (e.g., using CRTs technology) as well as digital technologies (e.g., HDTV supporting interlaced format). A user interface 201 such as a wireless remote control device (using a signal transmission method such as infrared, RF, inductive, or any other available method) may communicate with the television system. In the present embodiment, the remote control device contains a mechanism (e.g., a joystick, track ball, touch pad, mouse, lever, etc.) by which the user can manipulate a cursor on a television screen. Of course, remote control device could also be any one of numerous control devices known in the art, including a wireless keyboard, a wireless pointer device, etc. It is also possible not to use a remote control device at all, and to just use a key pad, cursor, etc., attached directly to the television system.

In the embodiment illustrated by FIG. 2a, the software architecture of the programming system 200 resides in a set-top box 210. The set-top box 210 typically includes the user interface 201 which comprises a CPU coupled to a read-only memory (ROM) and a random-access memory (RAM) (not show in this view). The ROM includes instructions and data for executing on the CPU. The RAM is used for storing program variables for the program instructions contained in the ROM. In another embodiment, the software architecture of the system may reside in the television system or may be built into a VCR.

A presentation engine 202 has drivers or connectors 205 a through n. One such driver is driver 203 which connects to the operating system within the set-top box 210 and allows the presentation engine 202 to communicate with such things as a television tuner, data for replenishing programming information, and the like. In addition, there is a memory or database 220 in the system, which contains objects 215 a through n. In the present embodiment, the database 220 resides in the memory. However, since the architecture of the here-referenced system also has hard disks, the database may also be in the hard disk, or in both the memory and the hard disk. An interface 204 provides for a 3-D enabled EPG virtual world whose end result is the view that the user gets. Rather than hard-programming one world into the application and allowing objects such as programs, etc., to be filled-in, numerous objects 215 a through n contain various world descriptions.

The interface 204 displays objects with real shapes on a television screen along with rectangular or bar shaped text blocks (rather than displaying a matrix of rectangular boxes containing text). For example, one method for displaying real shapes involves using 3-D accelerator technology. In one embodiment, the graphics circuitry that provides the information displayed on the television screen stores the image elements in a 3-D model and generates the image using a 3-D accelerator. This is done in a manner similar to that described in our U.S. patent application Ser. Nos. 09/344,442 filed on Jun. 25, 1999, entitled “METHOD AND APPARATUS FOR USING A GENERAL THREE-DIMENSIONAL (3D) GRAPHICS PIPELINE FOR COST-EFFECTIVE DIGITAL IMAGE AND VIDEO EDITING, TRANSFORMATION, AND REPRESENTATION” and 09/361,470 filed on Jul. 27, 1999, entitled “METHOD AND APPARATUS FOR 3-D MODEL CREATION BASED ON 2-D IMAGES” and our co-pending application 09/488,361 filed on Jan. 16, 2000, entitled “Electronic Programming Guide” (all of which describe 3-D accelerator technology and are incorporated herein by reference). Briefly, this is accomplished by a) storing a computer model of a geometric surface of one or more pictograms in a first set of memory locations within the television STB; b) storing within a second set of memory locations a two dimensional image to be mapped onto that surface (e.g., a pixel array); and c) constructing a pixel array comprising image.

According to the present embodiment, a variety of world descriptions in the objects 215 a through n provide the user with schedule information (or other information as typically presented in EPGs or IPGs) for broadcast programs using the 3-D accelerator technology mentioned herein. These 3-D enabled objects 215 provide a 3-D virtual world whose end result is the view that the user gets. For example, one layout may mimic a futuristic science fiction type of environment in space, with rotating carousels showing movie previews (not shown in this view). Another layout may offer, for example, an environment mimicking video games, such as Doom™, etc. (not shown in this view). Still another environment may offer the look of a classic 2-D EPG approach (not shown in this view).

In these various environments, channels (not shown in this view) may be organized by different classes, so the EPG world may contain, in addition to its layout and world descriptions, a through n elements with objects 215. In turn, each of those objects would then be linked or assigned to one of the items to display, such as schedule items, etc. In addition, there may be a dynamic relationship between the selection by the user of a specific content and the selection of a specific world (e.g., the selection of the sports channel by the viewer changes the world to a ballpark, the selection of the Disney channel changes the world to a Disney world, etc.).

Another class of objects 215 contain a pseudo-descriptive language. Such an object may convert a title or channel identification into an actual channel or program association.

There may also be non-EPG objects 215, such as interaction objects. These may be used for e-commerce activities, etc., and may be mixed in with the presentation of the world along with the programming schedule items. For example, the selection of the sports channel by the user may bring forth a virtual world with the image of a large baseball and bat and a logo indicating that a baseball game is being shown on a particular channel. By clicking on the logo, a user may obtain a list of products that may be purchased using an interactive television system in a manner well known in the art.

In one embodiment, the user can customize which EPG world he wants based on user preferences. For instance, EPG worlds can be catered to age categories of viewers, with particular worlds selected for the interests of senior citizens, teenagers, children, etc. In another embodiment, the programmer may decide which world the user views. For example, CNN may make a deal with the programmer saying that all CNN channels are to appear in the News World and not the viewer's chosen environment. Or, the programmer may offer 2-3 different world choices, and the viewer may choose among them. Of course, numerous other programming options are available in the system as well.

Referring now to FIG. 2b there is shown the overview of the software architecture of the programming system for the EPG of FIG. 2a including an interactive network communication block. FIG. 2b is essentially the same system as is shown in FIG. 2a, with the addition of the block 225 which includes a network link 230. In the embodiment illustrated by FIG. 2b, the network link 230 connects the block 225 to a server (not shown in this view) through the Internet 235. Alternatively, the network link 230 may connect the block 225 to the server through a corporate intranet, a Wide Area Network (WAN), a Local Area Network (LAN), or any other system of interconnections enabling two or more computer systems to exchange information. Further, network may also include a wireless network. The server may comprise one or more servers, either physical and/or software, networked, at one or more locations.

Block 225 has the ability to upload in real time new objects with localized content transmitted from the server and to dump those via a software driver acting as a connector 205 into the database 220. One example of such an upload would be localized advertisements for a local franchise of a pizza parlor during a football game. The national franchiser would contact the broadcaster to include localized content and permit users to enter an order on-screen through the user interface 201. The pizza could then be delivered by the local franchise to the users' locations, known to the service provider. If desired, billing may be handled through the block 225 as well.

Referring now to FIG. 2c there is shown the overview of the software architecture and interactive network communication block of FIG. 2b including an additional long-term storage database. The long-term storage database 240 may hold objects 250 a through n for an additional period of time such as a week, a month, or even years after a scheduled event. The long-term storage database 240 may be in the set-top box 210 and/or in an added offline archive 245 containing years of information. The archive 245 may be accessible through an interface module 226 in block 225 and accessible via network link 230 from one or more servers coupled to the network 235. In this context, offline means that the objects are stored on the one or more servers and accessible through the network 235.

If the object is not in the long-term storage database 240 then a software driver acting as a connector 206 and block 225 can be used by the long-term storage database 240 to search for additional objects and/or copies of original objects stored in the added online archive 245. These objects may be downloaded per user requests for renewed viewing of the header information. Additional services may also include allowing a user to download past episodes of specific shows in a manner similar to an interactive video-on-demand environment which is well known in the art. However, rather than having to buy an entire block of old shows the user could, for example, search specifically for a “Seinfeld” episode in which Kramer was hit in the face by a cake.

Of course, the options available in the system for users to search for past television events and to research details regarding these events are numerous and varied. For example, the long-term storage database 240 may be used to fill in the unused space in the memory and/or hard disk (not shown in this view) in the set-top box 210 and, depending on the requirements of other elements, more or fewer elements may be purged. However, because the added offline archive 245 is available and accessible to the system through the network 235, backup availability is not a problem.

Referring now to FIG. 2d there is shown the embodiment of the invention illustrated by FIG. 2c with the addition of a removable storage medium. A removable storage drive reads from and/or writes to a removable storage medium 265 (e.g., a CD ROM or DVD ROM connected to the set-top box via a logical connection). Removable storage medium 265 has the ability to receive recorded movies 211 a through n, as well as objects related to those movies, for example objects 215 a through n and objects 250 a through n. When a user chooses to record a movie or other program, or to transfer a recording to the removable storage medium 265, then associated objects such as overlays, annotations, links, etc., are copied along with it so that they will be available over time. For example, recording 262 has been moved to removable storage medium 265, along with associated objects 263 and 264. Alternatively, associated objects drawn from object array 250 a through n may be retrieved from the added offline archive 245 in a manner previously described.

By moving video files and their associated objects onto a removable storage medium 265, the medium can contain all of the components of the original broadcast (i.e., the main video file and all of its collected associated objects that are somehow related). For example, the collected associated objects may include programming guide information, trailers, annotations, video clips, overlays, links to Web sites, and any other objects associated with the original showing of the program. In this manner, with one simple push of a record button coupled to the set-top box 210, for example, the user may preserve not just the video itself but all of its associated data. The collective move may be accomplished by parsing the long-term storage database 240 so that all objects related to or linked to the movie or event selected by the user are copied and/or moved accordingly. Thus, the user has the benefit of easily storing virtually unlimited amounts of full video programming, without being constrained by requirements involved in the technical details of the process.

In some cases an object, for example, may only be added to the removable storage medium 265 if the company placing the advertisement paid an extra fee for doing so, thus preserving the advertisement value into future replays, rather than just one time. This may also apply to certain links. In addition, certain objects and/or links may be dated. Once the expiration date is reached, they may be ignored at playback time, or in some cases they may not even be stored on the removable storage medium 265.

In yet other cases, the user may only move or select the main object, and all linked objects, files, etc., may be copied or moved. In some instances, this may even include prefetching linked pages on the Web up to a certain depth (e.g., three links removed) and storing those as well on the removable storage medium 265. Thus, the user could view relevant Web pages even after they have been removed from the Web site, and without the user needing to access the Internet at the time of the viewing. In still other instances, these Web pages may be received as a simulcast in real time during a broadcast, and be stored temporarily in the system, before moved or copied to the removable storage medium 265.

It should be noted that in some instances it may be desirable to start recording 1-2 minutes or a similarly short time period before the actual program start time, and also to terminate 1-2 minutes or a similarly short time period before or after the actual program. This allows for a divergence of real time versus actual broadcast time as television networks sometimes intentionally start programs a few minutes early or late.

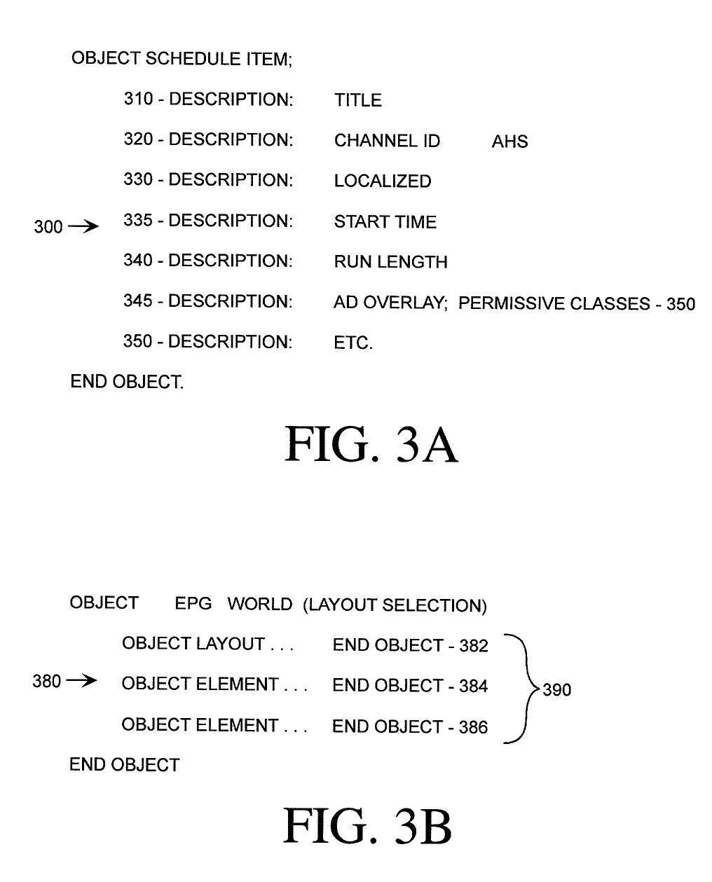

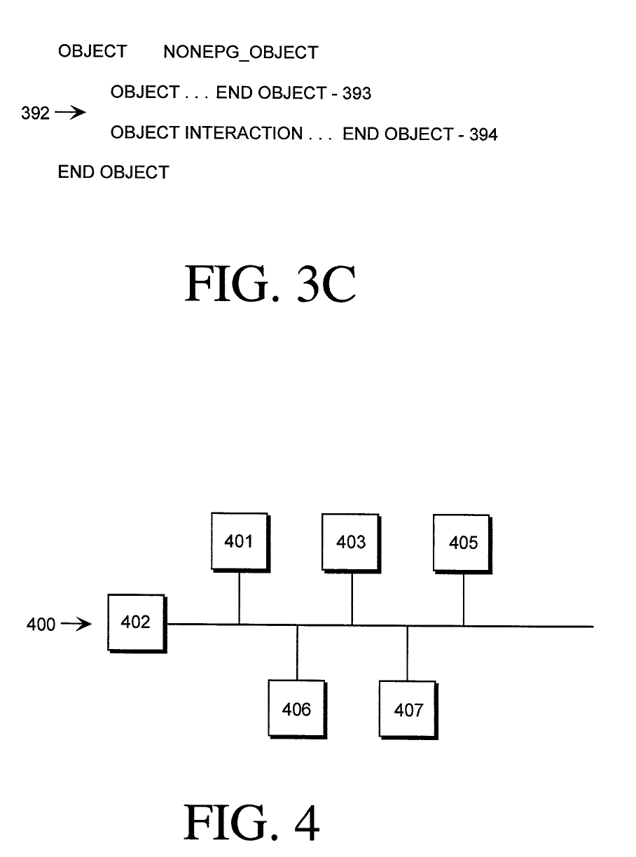

Referring now to FIG. 3a there is shown a pseudo-descriptive language containing one class of objects for an EPG 300 according to an embodiment of the present invention Such an object as shown in FIG. 3a has a title 310 and/or a channel identification 320 that may be converted into the actual channel number or program association. For example, Channel 7 may be converted to ABC, etc. It may have localized aspects such as local start time 335, run length or end time 340, ad overlay 345, permissive choice of advertisements 350, etc. Other important parameters 360 may also be included in the class of objects as demonstrated in FIG. 3a.

Referring now to FIG. 3b there is shown a description of a 3-D world in another class of objects for an EPG 380 according to an embodiment of the present invention. Objects 382, 384, 386, etc., may be used to build the world and then the entire world description 390 is an object itself.

Referring now to FIG. 3c there is shown a description of a non-EPG object 392 according to an embodiment of the present invention. The objects 393 and 394, etc., in FIG. 3c may be interaction objects and can be used for e-commerce activities. The objects 393 and 394, etc., may be mixed in the presentation of the world along with the schedule item objects (not shown in this view).

The system and method disclosed herein may be integrated into advanced Internet-or network-based knowledge systems as related to information retrieval, information extraction, and question and answer systems. FIG. 4 is an example of one embodiment of a computer system 400. The system shown has a processor 401 coupled to a bus 402. Also shown coupled to the bus 402 are a memory 403 which may contain objects (See FIG. 2 objects 215 a through n). Additional components shown coupled to the bus 402 are a storage device 405 (such as a hard drive, floppy drive, CD-ROM, DVD-ROM, etc.), an input device 406 (such as a keyboard, mouse, light pen, barcode reader, scanner, microphone, joystick, etc.), and an output device 407 (such as a printer, monitor, speakers, etc.). Of course, an exemplary computer system could have more components than these or a subset of the components listed.

The system and method described herein may be stored in the memory of a computer system (i.e., a set-top box) as a set of instructions to be executed, as shown by way of example in FIG. 4. In addition, the instructions to perform the system and method described herein may alternatively be stored on other forms of machine-readable media, including magnetic and optical disks. For example, the system and method of the present invention may be stored on machine-readable media, such as magnetic disks or optical disks, which are accessible via a disk drive (or computer-readable medium drive). Further, the instructions may be downloaded into a computing device over a data network in the form of a compiled and linked version.

Alternatively, the logic to perform the system and method described herein may be implemented in additional computer and/or machine-readable media such as discrete hardware components as large-scale integrated circuits (LSI's), application specific integrated circuits (ASIC's), firmware such as electrically erasable programmable read-only memory (EEPROM's), and electrical, optical, acoustical, and other forms of propogated signals (e.g., carrier waves, infrared signals, digital signals, etc.).

Thus, a system and method for transparent object management for removable media recorders has been described. Although the foregoing description and accompanying figures discuss and illustrate specific embodiments, it should be appreciated that the present invention is to be measured only in terms of the claims that follow.

What is claimed is:

1. A system, comprising:
a first unit to generate an interactive 3-D electronic programming guide (EPG); and
a removeable storage medium to store data associated with past programming events.

2. The system of claim 1 wherein the system comprises a set-top box, a television, or a VCR.

3. The system of claim 1 wherein the system includes a plurality of drivers, one of the drivers communicating with a separate unit to replenish programming information.

4. The system of claim 1 wherein a memory in the system contains a plurality of objects associated with current programming events, a first class of objects providing plurality of virtual worlds included in the 3-D EPG.

5. The system of claim 4 wherein the memory in the system includes a second set of objects that includes at least one of a schedule times, channel identification, or title, corresponding to a program.

6. The system of claim 5 wherein the second set of objects includes localized content.

7. The system of claim 4 wherein the memory in the system includes a third set of non-EPG objects including objects used for e-commerce.

8. The system of claim 1 wherein the 3D EPG includes a presentation of a virtual world related to content selected by a user.

9. The system of claim 8 wherein a subset of the virtual world is displayed as a matrix of rectangular boxes containing current program information.

10. The system of claim 6 wherein the localized interactive content of the third set of objects is uploaded in real time.

11. The system of claim 10 further including a user interface for a user to interact with the localized interactive content of the 3D EPG.

12. The system of claim 1, wherein the data to be stored on the removeable storage medium includes digital video.

13. The system of claim 1 wherein the data to be stored on the removeable storage medium includes digital video and associated objects.

14. The system of claim 13 wherein the associated objects includes at least one object selected from a group consisting of programming guide information, trailers, annotations, video clips, overlays, and links to Web sites.

15. The system of claim 14 wherein the associated objects include expirations.

16. A method, comprising:
generating an interactive 3-D electronic programming guide (EPG); and
providing a removeable storage medium to store data associated with past programming events.

17. The method of claim 16 further including storing in a memory of a system a plurality of objects associated with current programming events.

18. The method of claim 17 performed by a set-top box, a television system, or a VCR.

19. The method of claim 17 wherein the plurality of objects includes a first set of objects providing plurality of virtual worlds included in the 3-D EPG.

20. The method of claim 19 wherein the plurality of objects includes a second set of objects that includes at least one of a schedule times, channel identification, or title, corresponding to a program.

21. The method of claim 20 wherein the second set of objects includes localized content.

22. The method of claim 21 wherein the plurality of objects includes a third set of non-EPG objects including objects used for e-commerce.

23. The method of claim 22 wherein the 3D EPG includes a presentation of a virtual world related to content selected by a user.

24. The method of claim 23 wherein a subset of the virtual world is displayed as a matrix of rectangular boxes containing current program information.

25. The method of claim 24 further including uploading the localized interactive content of the third set of objects in real time.

26. The method of claim 25 providing a user interface coupled to the EPG for a user to interact with the localized interactive content.

27. The method of claim 26 further including providing a user interface for a user to interact with the localized interactive content of the 3D EPG.

28. The method of claim 16, wherein the data to be stored on the removeable storage medium includes digital video.

29. The method of claim 16, wherein the data to be stored on the removeable storage medium includes digital video and associated objects.

30. The method of claim 29 wherein the associated objects includes at least one object selected from a group consisting of programming guide information, trailers, annotations, video clips, overlays, and links to Web sites.

31. The method of claim 14 wherein the associated objects include expirations.

32. A machine-readable storage medium tangibly embodying a sequence of instructions executable by the machine to perform a method for providing for a 3-D enabled electronic programming guide (EPG), the method comprising:
generating an interactive 3-D electronic programming guide (EPG); and
providing a removeable storage medium to store data associated with past programming events.

33. The machine-readable storage medium of claim 33 stored in a set-top box, a television, or a VCR.

34. The machine-readable storage medium of claim 34 further including instructions to provide a plurality of drivers, one of the drivers communicating with a separate unit to replenish programming information.

35. The machine-readable storage medium of claim 34 further including instructions to provide a plurality of objects associated with current programming events, including a first class of objects providing plurality of virtual worlds included in the 3-D EPG.

36. The machine-readable storage medium of claim 35 wherein the plurality of objects includes a second set of objects that includes at least one of a schedule times, channel identification, or title, corresponding to a program.

37. The machine-readable storage medium of claim 36 wherein the memory in the system includes a third set of non-EPG objects including objects used for e-commerce.

38. The machine-readable storage medium of claim 37 wherein the 3D EPG includes a presentation of a virtual world related to content selected by a user.

39. The machine-readable storage medium of claim 38 wherein a subset of the virtual world is displayed as a matrix of rectangular boxes containing current program information.

40. The machine-readable storage medium of claim 39 wherein a user of the system chooses a virtual world to display programming information.

41. The machine-readable storage medium of claim 40 wherein the second set of objects includes localized content.

42. The machine-readable storage medium of claim 41 wherein the localized interactive content of the third set of objects is uploaded in real time.

43. The machine-readable storage medium of claim 42 further including a user interface for a user to interact with the localized interactive content of the 3D EPG.

44. The machine-readable storage medium of claim 32, wherein the data to be stored on the removeable storage medium includes digital video.

45. The machine-readable storage medium of claim 32, wherein the data to be stored on the removeable storage medium includes digital video and associated objects.

46. The machine-readable storage medium of claim 45 wherein the associated objects includes at least one object selected from a group consisting of programming guide information, trailers, annotations, video clips, overlays, and links to Web sites.

47. The machine-readable storage medium of claim 46 wherein the associated objects include expirations.

48. A System, comprising:
a first unit to generate an interactive 3-D electronic programming guide(EPG);
a removable storage medium to store data associated with past programming events, wherein the data to be stored on the removeable storage medium includes digital video and associated objects, wherein the associated objectd includes at least one object selected from a group consisting of programming guide information, trailers, annotations, video clips, overlays, and links to Web Sites;
a plurality of drivers, one of the drivers communicating with a separate unit to replenish programming information; and
a memory in the system contains a plurality of objects associated with current programming events, a first class of objects providing plurality of virtual worlds included in the 3-D EPG, a second set of objects that includes at least one of a schedule times, channel identification, or title, corresponding to a program, and a third set of non-EPG objects including objects used for e-commerce.

49. The system of claim 48 wherein the system comprises a set-top box, a television, or a VCR.

50. The system of claim 49 wherein the second set of objects includes localized content.

51. The system of claim 48 wherein the 3D EPG includes a presentation of a virtual world related to content selected by a user.

52. The system of claim 51 wherein a subset of the virtual world is displayed as a matrix of rectangular boxes containing current program information.

53. The system of claim 48 wherein the localized interactive content of the third set of objects is uploaded in real time.

54. The system of claim 48 further including a user interface for a user to interact with the localized interactive content of the 3D EPG.

55. The system of claim 54 wherein the associated objects include expirations.

56. A system, comprising:
a first unit to generate an interactive 3-D electronic programming guide (EPG); and
a removeable storage medium to store data associated with past programming events, wherein the data to be stored on the removeable storage medium includes digital video and associated objects, wherein the associated objects includes at least one object selected from a group consisting of programming guide information, trailers, annotations, video clips, overlays, and links to Web sites.
